(19) United States
(12) Patent Application Publication
(10) Pub. No.: US 2006/0086802 A1
(43) Pub. Date: Apr. 27, 2006

(54) Gemstone-carrying items, methods of its fabrication, and uses of such items

(76) Inventor: Jean-Paul Tolkowsky, Antwerpen (BE)

Correspondence Address: BROWDY AND NEIMARK, P.L.L.C., 624 Ninth Street, N.W., Washington, DC, 20001, US

(21) Appl. No.: 10/972,782

(22) Filed: Oct. 26, 2004

(51) Int. Cl. G06K 19/00

(52) U.S. Cl. 235/487

(57) ABSTRACT

A carrier associated with a certain item is presented. The carrier has a pattern formed by a plurality of gemstones affixed to the carrier with at least part of each gemstone being directly exposed to view. This technique allows for configuring the item to present added value to the item provider and/or item holder and/or gemstone provider. The technique is particularly useful with plastic identification cards, such as credit cards.

### FIELD OF THE INVENTION

This invention relates to gemstone-containing items, and methods for fabricating and using such items. The invention is particularly useful for credit cards.

### BACKGROUND OF THE INVENTION

A technique of introducing one or more distinctive gems into a credit card has been developed, aimed at reducing fraud. This technique is disclosed in U.S. Pat. No. 4,931,629. According to this technique, a credit card comprises a plastic base layer containing one or more distinctive gems retained therein. The gems are disposed within holes in the plastic base of the credit card or embossed under pressure into it, and are covered with transparent sealing layers, which secure the gems in their place. Since, for example, no two gems such as diamonds are alike, the gems can be recorded as unique to one credit card holder. The unique light scatter pattern or characteristic of the gem can be determined, this pattern or characteristic can be recorded corresponding to the name of a credit card holder. The possibility of fraud is thus substantially reduced.

U.S. Pat. No. 5,475,910 describes a jewel setting method comprising the steps of: making a hole in an elastic object; forming overhangs around the top circumference of the hole; and press-fitting a jewel into the hole by causing the jewel to pass through the space delimited by the surrounding overhangs to be yieldingly withdrawn, allowing the girdle of the jewel to pass through the space delimited by the surrounding overhangs, and then, allowing the overhangs to return to their original positions, thereby catching the bezel of the jewel.

U.S. Pat. No. 4,052,863 describes a component comprising a plurality of gemstones containing visible faces and seating faces. The component is made in an apparatus that includes a plate with a heating chamber on one side and a vacuum chamber on the other. The stones are arranged in recesses on the plate with their seating faces outward, a sheet of adhesive foil is positioned thereover, heated into a thermoplastic state and drawn down by vacuum to surround and adhere to the seating faces. The component is then placed in a recessed jewelry setting with each stone in a recess, and again heated to fuse the foil to the setting.

### SUMMARY OF THE INVENTION

There is a need in the art for a technique providing for distributing items (products) designed so as to provide an added value to the provider of such items (e.g., an identification card such as a credit card; a compact disk; an electronic device, a watch, etc.) and/or a holder of such item (e.g., credit card holder) and/or a gemstone provider, by designing the item to have a certain mark (design feature) associated with the item provider and/or the item holder and/or the gemstone provider.

The present invention provides a novel carrier having a certain pattern formed or outlined by a plurality of gemstones, a method for producing the pattern, as well as a technique for adding certain value to the provider and/or the holder of such a patterned carrier and/or to the provider of gemstones to be used to create the pattern. The gemstones are embedded in or attached to the carrier in a manner that each gemstone is at least partly exposed to direct view (preferably without intervening layers). The carrier may be the item itself (such as for example in the case of an ID card or compact disk), or may be part of the item, integral with or attachable to the item so as to be a constructional and/or ornamental part thereof (such as for example a display panel of a phone device or a watch).

It should be noted that the term “carrier” as used herein refers to any item (product), made from any suitable material, including for example polymers, thermosetting plastics, thermoplastics, glass, metals, etc., to which multiple gemstones or a multiple-gemstone supporting structure can be attached. The carrier may for example be a data carrier, certain data being embedded therein and/or printed thereon. The term “identification card” or “ID card” used herein signifies a plastic card (such as a credit card) carrying one or more data fields, for example data related to a card provider and/or a card holder. The term “pattern” signifies a symbol, letter, logo or the like, or any other geometric shape formed by an array of gemstones, arranged in accordance with the respective symbol, letter, logo, or geometrical shape. The pattern may be presented within the existing data field of the carrier or a new field introduced in the carrier especially for the purposes of the invention, namely to be patterned with gemstones. The multiple-gemstone pattern may be associated with at least one of the carrier provider (e.g., the credit card provider), the carrier holder (e.g., the credit card holder), and a gemstone provider.

The term “carrier provider” signifies a company manufacturing and/or distributing an item including or being such a carrier as defined above. The term “card provider” refers to a company, individual or group of individuals that is distributing plastic cards (to be used as ID cards), free of charge, or against certain payment, for the purpose of using them as means of making money through transactions related to the card or as a promotional means, or as a security means, or as means for providing a warranty, or for other purpose. A special case of a card provider is a “credit card provider”, such as American Express® Company, Visa International®, etc.

The term “carrier holder” defines an individual, group of individuals or company to which the carrier provider issues such a carrier (included in or being an item) for various uses; for example an “ID card holder” is an individual or company to which the card provider issues the card for such uses as payment by credit, withdrawing money from an ATM machine, getting discounts (as a club member), etc. In some cases, the carrier (card) holder's name is inscribed on the carrier (e.g., embossed on the ID card).

The term “gemstone provider” defines one or several of the following: gemstone manufacturer, gemstone distributor, jewel distributor, jeweler, jewel and gemstone retail chains, jewel and diamond retailer, and the like. A gemstone provider may for example be also a carrier provider. A diamond provider is a particular case of a gemstone provider, specializing in the diamond business.

Considering such a carrier (e.g., identification cards) which in order to be identified (i.e., data embedded therein or printed thereon is to be read (by “reading” is meant hereunder, a generally automatic process of interpreting or decoding specific data inscribed or existing within the carrier) are subjected to optical, RF, magnetic or other external field, the gemstone-pattern can be designed so as not to affect the data reading operation. Considering, for example, that the data carrier is read while the carrier is located in a reading device or passed through a reading slot, the gemstones may be embedded in the carrier such that they do not impede the reading operation (e.g., do not protrude from the outer surface of the carrier).

It should be understood that generally, the technique of the present invention may be used with any gemstones. Preferably, the invention utilizes diamonds, and more preferably polished diamonds. Where the gemstones or diamonds are polished similarly to a round “brilliant” cut or any other cut defining a table and possibly also a crown, the part exposed for viewing is preferably at least the gemstone/diamond's table, and more preferably, also portions of the gemstone/diamond's crown. The gemstone may or may not protrude out of the carrier, depending on the height of the gemstone, depth of insertion, carrier thickness, as well as design, production and costs requirements and limitations. It should be understood that a “table” of a polished gemstone or a polished diamond is known in the gemstone/diamond jewelry as a flat face that is to be exposed to a viewer's eyes, when the gemstone or diamond is set in a jewel.

The pattern formed or outlined by gemstones may or may not be meaningful, namely, may or may not be included in a data field of the carrier or present by itself certain readable data. Non-limiting examples of meaningful patterns are symbols, alphabet-letters, a logo or part of it, and the like (e.g., a part of, or the entire trade name and/or trade mark of the credit card provider). A non-meaningful pattern may be any other geometric shape formed by a plurality of gemstones.

The gemstones are affixed to the carrier such that they are kept in place during the typical use of the carrier, including temporal bending, rubbing, falling, and the like. The present invention enables to attach a “group” or “matrix” or “cluster” of several diamonds together to a carrier, e.g., plastic card (e.g., ID card, e.g., credit card), while preferably keeping the basic characteristics of the carrier (e.g., flexibility) and preventing the gemstones from falling over or moving, due to flexing or hitting, or using the carrier in a typical manner such carriers are used.

The carrier may be a plastic substrate. In this case, gemstones, preferably diamonds, may be affixed to such a plastic carrier (such as an ID card) by local heating of the plastic material (direct heating or by heat transfer) of the carrier while applying slight mechanical pressure to the directly heated location of the plastic material or to a location of the carrier in the vicinity of the heated location (e.g., to the gemstone); or are affixed to the plastic carrier by using a specifically designed clamping mechanism; or are affixed to the carrier via a specifically designed support structure which is patterned by gemstones and appropriately attached to the carrier.

Considering local heating of a plastic carrier, the gemstone-containing carrier has, in the vicinity of the gemstone, plastic material that is softened/melted so that it irreversibly deforms so as to relocate above the gemstone in overhang(s), and then, when such overhang(s) become(s) hardened after the local heating is discarded, it affixes the gemstone to the carrier. Similar one or more overhang is produced above the embedded heat conductive elements, in such embodiments where they are used, affixing it to the carrier. Such a carrier and method of its patterning by gemstones using local heating of the plastic material, are advantageously free of mechanical stress, which is virtually not the case with mechanical embossing-under-pressure techniques.

It should be understood that it is sufficient to heat the plastic material up to the point that it becomes “softened/melted”, namely becomes non-solid plastic material, irreversibly deformed, so that it shifts to fill a free space in its vicinity. To this end, a temperature between about 100° C. and 160° C. and a mechanical pressure corresponding to a force of about 100-200 gram may be sufficient, depending mainly on the specific plastic material from which the carrier is made and on the applied pressure.

Considering local heating of the plastic material, the gemstone and other embedded elements (in such embodiments where they are used) can be non-heat conductive, provided they are first separately heated to the proper temperature, before being affixed to the plastic carrier. It should be noted here that also heat-conductive gemstones and elements can be embedded using this method of first separate heating of the gemstone.

The gemstone is preferably positioned so as to be exposed to direct view without intervening layers, such as transparent sealing layers which, even if considered perfectly transparent for other purposes, might diminish the observed brilliance of the gemstone, as they interfere with light impinging on and/or into the gemstone, and then reflected and/or refracted therefrom. It should, however be noted that generally, a laminating/protecting transparent layer may be affixed on the carrier and the gemstone/diamond embedded therein.

According to one embodiment, the local heating of the plastic material is performed by applying heat directly to the gemstone, together with slight mechanical pressure, either when the gemstone is located in a recess made in the carrier, or while directly pressing the gemstone into the plastic material without recurring to a pre-prepared recess. In these cases, the gemstone is heat-conductive so that it transfers the heat applied to it to the plastic material in the vicinity thereof. Local heating applied to the plastic material via the gemstone is ideal for incorporating diamonds into a plastic carrier, as a diamond is an excellent heat conductive substance. As indicated above, a non heat-conductive gemstone may be used as well, in a similar way, provided it has been heated separately to the proper temperature prior to be inserted into the carrier.

As indicated above, the local heating is accompanied by the application of mechanical pressure to the gemstone. The heating and pressing may be done after a proper recess has been made in the carrier to receive the gemstone therein. The recess is made smaller than the gemstone in angle, in height, etc. Upon heating, softened/melted plastic material irreversibly deforms and is shifted so as to fill a remaining free space of the nearby recess (such free space constituting a low resistance to the softened/melted plastic), so that the softened/melted plastic material wraps a part of the gemstone, including the peripheral part of the outer/upper surface of the gemstone. The softened/melted plastic creates a plastic overhang that become hardened after the heat has been removed so that the plastic material cools down, and consequently affixes the gemstone in place (e.g., holds a brilliant cut diamond fast by its crown). This shifting/relocation of the displaced softened/melted material to a close by low resistance region of the recess, allows the surface of the recess to relax from stresses, despite the existence therein of a gemstone that is larger than the original size of the recess. The same process takes place when the gemstone is inserted by applying direct heating without having any pre-prepared recess.

Another example of affixing the gemstone to a plastic material of a plastic carrier by heating the plastic, is utilizing a gemstone that is indented, i.e., having a certain surface relief (e.g., by laser), in the part of the gemstone that is inserted into the carrier (e.g., in the pavilion of a brilliant cut diamond). When the gemstone is then inserted in a recess made in the plastic carrier, or pressed into the carrier with no pre-prepared recess, and the same heat and mechanical pressure are applied, the softened/melted and then irreversibly deformed plastic not only relocates as above so as to create an overhang, but while wrapping the periphery of the gemstone, it also penetrates these indentations, so that when hardened after the heat is removed, it additionally affixes the gemstone to the plastic carrier. As an example, the overhang can be removed, and the gemstone may remain affixed to the carrier by the hardened plastic that was introduced into the indentations. As indicated above, the gemstone is either heat-conductive, or non heat-conductive in which case it is to be heated separately to the proper temperature prior to be inserted into the plastic carrier.

According to another embodiment, local heating and mechanical pressure (e.g., of scales similar in temperature and in mechanical pressure as described above) may be applied directly to the plastic material of the carrier at location(s) in the vicinity of the gemstone. In this case, the gemstone is placed in a recess previously provided in the carrier. The recess' size is preferably equal to or larger than the part of the gemstone that is to be inserted therein. The gemstone may be properly aligned in the recess by vibrating the carrier or by any other appropriate means. Local heating with a slight mechanical pressure is then applied directly to the plastic carrier, in the vicinity of the recess, by an appropriately designed heat applicator being brought in contact with the carrier in at least one region or preferably in a plurality of contact regions. The application of heat together with slight mechanical pressure in the vicinity of the gemstone results in that the plastic material in the vicinity of the gemstone is softened/melted and irreversibly deforms, so as to shift and relocate in the recess, creating an overhang around the periphery of the upper surface of the gemstone, which is in the recess. This overhang, when being cooled and hardened after the heat has been removed, affixes the gemstone to the recess. In the case of a polished gemstone/diamond having a crown and a table such as a brilliant cut, the overhang can be made to cover only the periphery of the crown. The contact regions may be arranged in a spaced-apart relationship or in a continuous contour, surrounding the recess; e.g., the contact area may be along a circle around the recess, or at several distinct points around the recess. After applying heat, the heat applicator may leave on the carrier small marks at the spots contacted thereby, and when properly designed, these may be used as ornaments, decorating the surrounding of the gemstone. For example, application of heat at about 4 to 8 distinctive points around the gemstone allows obtaining respective 4 to 8 overhang points above the upper, outer periphery of the gemstone, thus permitting a maximal exposure of the gemstone to view without compromising the strength at which the gemstone is affixed to the carrier. In the case of a polished gemstone/diamond having a table and a crown such as a brilliant cut diamond, a part of the table or its entity and a part of the crown will remain exposed to view.

It should be noted that the local heating of the plastic material may be achieved by simultaneously applying heat to the gemstone and to the plastic material in its vicinity, in which case the pressure is applied to the gemstone and/or the plastic material being heated.

It should also be noted that a dedicated heat applicator may be designed for the direct application of heat to the gemstone and/or the plastic material in the vicinity of the gemstone, as well as for heat application via a separate heat conductive element as described below. The heat applicator is preferably designed such that, when used, it applies both heat and mechanical pressure. For example, the heat applicator's weight may be sufficient to provide proper pressure when it is laid on the plastic material and/or gemstone.

According to yet another embodiment of the invention, the gemstone is inserted in a recess of equal or larger size than that of the gemstone part inserted in the recess. Local heating is applied indirectly to the plastic material of the plastic carrier, by means of a heat conductive element, such as a metal ring, located above the gemstone. The width of the outer perimeter of the conductive element is larger than the width of the opening of the recess, while the inner perimeter of the conductive element is smaller than the gemstone width (e.g., in case of a round brilliant cut, the outer diameter of the heat conductive element is larger than the width of the opening of the recess in which the gemstone is inserted, and the inner diameter of the heat conductive element is smaller than the girdle diameter). In this way, the heat conductive element is held by the gemstone outer/upper perimeter (e.g., by the crown or table of a brilliant cut). By applying heat and mechanical pressure to the heat conductive element (by using an appropriately designed heat applicator), a plastic overhang is created as in the former method, around the outer perimeter of the heat conductive element (this area being of a low resistance to the softened/melted, irreversibly deformed plastic), while the heat conductive element is inserted into the plastic carrier, thus affixing it thereinside, thereby affixing also the gemstone to the plastic carrier, thereby strengthening the forces retaining the gemstone inside the plastic carrier. The part of the gemstone within the inner perimeter of the heat conductive element (e.g., preferably the entire table and part of the crown of a brilliant cut) is free and exposed to the viewer. The temperature and mechanical pressure scales are similar to those of the previously described embodiments. In case the plastic carrier (e.g., identification card or CD) is readable by specific means (e.g., magnetic or RF means), it should be understood that the heat conductive element can be made of a substance that does not interfere with the means used for reading information from the plastic carrier, e.g., non-metallic heat-conductive substances may be preferable.

This process can be done, as previously, by directly pressing the gemstone and the heat conductive element, while heating, into the plastic material without recurring to a pre-prepared recess. In these cases, the gemstone is heat-conductive for transferring heat to the plastic material in the vicinity thereof. The element such as a ring and/or the gemstone can be non heat-conductive, provided that they are separately (externally) heated to the proper temperature, and then, while hot, inserted into the plastic carrier.

According to yet another embodiment of the invention, the gemstone is inserted in a recess of equal or larger size than the inserted part of the gemstone. Local heating is applied indirectly to the plastic material of the plastic carrier, by means of a heat conductive element, such as a metal ring, located outside of the recess. The width of the outer and inner perimeters of the conductive element are both larger than the width of the opening of the recess (e.g., in case of a round brilliant cut, the outer and inner diameters of the heat conductive element are both larger than the width of the opening of the recess in which the gemstone is inserted). By applying heat and mechanical pressure to the heat conductive element (by using an appropriately designed heat applicator), plastic overhangs are created as in the former method, around the outer and inner perimeters of the heat conductive element, thereby affixing it onto the plastic carrier. Concurrently, the softened/melted plastic, irreversibly deformed, relocates also around the nearby periphery of the upper surface of the gemstone (e.g., above the crown of a brilliant cut), this area being also of a low resistance. Thus, the gemstone is also affixed to the carrier. The temperature and mechanical pressure scales are similar to those of the previously described embodiments. In case the plastic carrier is readable by specific means (e.g., magnetic or RF means), it should be understood that the heat conductive element can be made of a substance that does not interfere with the means used for reading information from the plastic carrier, e.g., non-metallic heat-conductive substances may be preferable.

This process can be done, as previously, by directly pressing the gemstone and the heat conductive element, while heating, into the plastic material without recurring to a pre-prepared recess. In these cases, the gemstone is heat-conductive for transferring heat to the plastic material in the vicinity thereof.

The element as described above, such as the ring, can be made from non heat-conductive materials, provided that it is separately heated to the proper temperature, and then, while hot, inserted into the carrier.

According to yet another embodiment, a “support structure” is pre-prepared and patterned with gemstones. The support structure may be made out of a “luxury” material (such as gold or silver) used in jewels, and being heat conductive. As indicated above the gemstones pattern may be indicative of a logo and/or letter, etc., associated with the carrier provider and/or the carrier holder and/or with the gemstone provider. As for the support structure (base piece) carrying the gemstones, it also may be configured (shaped) according to the outline of such a letter or logo, etc, (e.g., of the trade name). Generally speaking, the support structure carries a plurality of gemstones presenting a certain pattern, which is defined by the support structure configuration entirely covered by the gemstones, and/or by the arrangement of gemstones within the base piece. The gemstones are set onto the support structure by one of existing conventional techniques used in jewelry. The base piece may be attached to a carrier (product) by any suitable technique. This may be achieved by gluing or mechanical fixing such as screws.

A recess may be pre-prepared in the surface of a plastic carrier shaped similar to the support structure, but slightly smaller in dimensions. For example, for the support structure of 5 mm height and 2 mm width, the recess may be 0.2 mm smaller. The depth of the recess can be made similar to the thickness of the base piece or slightly smaller. The support structure is then heated and mechanically pressed into the recess (as in the previously described embodiments), using a heat applicator configured to define an array of spaced-apart contacting members, to contact the support structure in regions where no gemstone is set. By heating and pressing the support structure into the recess, the plastic material in the carrier is softened/melted, being irreversibly deformed so as to settle as overhangs around the support structure. When the plastic material in the overhang hardens after the heat is removed, the support structure is affixed to the plastic carrier. The pattern of the gemstones, set in the embedded support structure, is entirely free to be seen by a viewer, except the setting regions, as in conventional jewelry.

The outer surface of the support structure, opposite to the surface carrying the gemstones or within a periphery region of the support structure, may be patterned to define protrusion/groove features (surface relief) shaped in such a way that the protrusions can be wrapped by the softened/melted, irreversibly deformed plastic material, so as, when hardened after the heat has been removed, they are held fast by the hardened plastic material that wraps those features; consequently, they also affix the base piece to the carrier. If properly done, these features may be strong enough to hold the support structure, and the overhangs may be removed.

This process can be done, as previously, by directly pressing the support structure containing the pre-set gemstones, while heating, into the plastic material without recurring to a pre-prepared recess. In these cases, the support structure material is heat-conductive for transferring heat to the plastic material in the vicinity thereof. The support structure as described above can be made from non heat-conductive materials, provided that it is separately heated to the proper temperature, and then, while hot, inserted into the card.

Thus, in the above-described embodiments, the gemstones are affixed to a plastic substrate of a carrier such as an ID card, using local heating of the plastic material of the carrier, wherein the gemstones are either directly affixed to the carrier or via support assemblies (a heat-conductive element initially separate from the gemstone, or a support structure to which the gemstones are initially set). As indicated above, yet another option for affixing the gemstone to the plastic carrier consists of using a specifically designed clamping member. Such a clamping member may utilize the principles of a (coned) Belleville Spring, known in the art of the mechanical industry as a piece of steel with high tensile strength (also called “Disc Spring” and “Conical Compression Washer”), while being specially modified in accordance with the invention. The clamping member is designed so as to be shiftable from its one low potential energy state, termed hereinafter “upper free state” into its other low potential energy state termed “lower free state”, through intermediate states termed “pre-deflected states”.

In this embodiment, the recess made in the carrier (substrate) is configured to receive the clamping member and allow its flipping therein through the different states. For example, the recess has a lower part of a certain diameter and an upper part of a larger diameter, where the clamping member is to be held. Consider for example a gemstone having geometry similar to that of a round brilliant cut, the recess is configured to define a cone-shaped portion and a cylindrical portion above the cone. The cone-shaped portion has dimensions substantially of the pavilion of the diamond, more specifically the same dimensions or slightly larger than the pavilion. The cylindrical portion has a diameter larger (e.g. by additional 0.2 mm to 0.5 mm for diamonds of 1 mm diameter) than that of the cone and is intended to receive the clamping member.

The clamping member (ring) has an outer diameter similar to the diameter of the cylindrical portion of the recess and an inner diameter smaller than the gemstone's largest diameter (e.g. girdle in the case of a brilliant cut) so that the clamping member is mountable onto the gemstone and, when placed into the recess, and flipped from its upper free state into a pre-deflected position, before reaching its lower free state, is stopped by the gemstone inserted in the recess (e.g. by the crown of a brilliant cut diamond), so as to be held by tension between the inner walls of the cylindrical portion of the recess, thus affixing the gemstone to the recess. The part of the gemstone within the inner perimeter of the clamping member (e.g., preferably the entire table and part of the crown) is free and exposed to the viewer. Preferably, the clamping member, in its peripheral region, is formed with a plurality of sharp spikes. This facilitates affixing the gemstone to the recess: the sharp metallic spikes, due to the pressure induced by the pre-deflected position of the clamping member, are forced to penetrate the softer plastic walls of the recess. The clamping member is left inside the plastic carrier, preferably as an ornamental feature (e.g., being gold plated).

Thus, according to one broad aspect of the invention, there is provided a carrier associated with a certain item, the carrier having a pattern formed by a plurality of gemstones affixed to the carrier with at least part of each gemstone being directly exposed to view.

According to another broad aspect of the invention, there is provided an identification card having a plastic substrate carrying a pattern formed by a plurality of gemstones embedded in the plastic material of the substrate with at least part of each gemstone being directly exposed to view. By “substrate” is meant the material a carrier is made of, entirely or partially.

As indicated above, the identification card may be a credit card, a club member card, etc.

According to yet another broad aspect of the invention, there is provided a credit card carrying a pattern formed by a plurality of gemstones embedded in a plastic material of the card with at least part of each gemstone being directly exposed to view.

According to yet another broad aspect of the invention, there is provided a credit card carrying a pattern formed by a plurality of diamonds embedded in a plastic material of the card with at least part of each diamond being directly exposed to view.

According to yet another broad aspect of the invention, there is provided an item carrying a plurality of gemstones mounted such that each of the gemstones is at least partly directly exposed to a viewer, the gemstones being arranged in a pattern configured to be indicative of at least one of the item provider, item holder and a gemstone provider.

According to yet another broad aspect of the invention, there is provided an identification card carrying a plurality of gemstones mounted such that each of the gemstones is at least partly directly exposed to a viewer, the gemstones being arranged in a pattern configured to be indicative of at least one of the card provider, card holder, and a gemstone provider.

According to yet another broad aspect of the invention, there is provided a credit card carrying a plurality of gemstones mounted such that each of the gemstones is at least partly directly exposed to a viewer, the gemstones being arranged in a pattern associated with at least one of a credit card provider, a credit card holder and a gemstone provider.

The present invention also provides methods for affixing a gemstone (e.g., diamond) to a plastic substrate (such as an identification card) using local heating with mechanical pressure; or using a specifically designed clamping member. These methods provide for ways of incorporating gemstones into plastic cards that are both economic and technologically simple, and when properly designed, allow for the addition of ornamental features.

The methods using local heating with mechanical pressure may be carried out with good results without the need of an extremely accurate process, as no recess is needed when pressure is applied to the gemstone while inserting it into the card, and in those embodiments where use is made of a recess into which the gemstone or support structure is introduced, the final shape of the recess is determined by the inserted gemstone and the way the softened/melted plastic hardens in the vicinity of the gemstone or support structure. These methods using local heating with mechanical pressure take advantage of the intrinsic characteristics of plastic material used in carriers such as identification cards (being softened/melted at relatively low temperatures, typically about 120-160° C.) and some of these methods make use of the intrinsic characteristics of certain gemstones, such as diamonds, being excellent heat-conductors, thereby enabling a simple and cost effective technique of marking identification cards by diamonds.

Thus, according to yet another aspect of the invention, there is provided a method for affixing at least one gemstone to a plastic carrier, the method comprising: affixing said at least one gemstone to a plastic substrate of the carrier in a manner leaving at least a part of the upper surface of the gemstone directly exposed to a viewer, said affixing comprising at least one of the following:
(i) directly embedding said at least one gemstone in the plastic material by applying heat to a plastic material of the substrate in the vicinity of the gemstone or an element mounted on the gemstone, thereby causing softening/melting of the plastic material in the vicinity of the gemstone or in the vicinity of said element so that said softened/melted plastic material irreversibly deforms and relocates, thereby creating at least one overhang above at least one region of the gemstone or of said element, said at least one overhang when hardened after the local heating is discarded affixing the gemstone to the plastic substrate;
(ii) providing a support structure carrying on its upper surface said at least one gemstone, and affixing said support structure to the substrate by applying heat to a plastic material of the substrate in the vicinity of said structure, thereby causing softening/melting of the plastic material in the vicinity of the support structure so that said plastic material in the vicinity of the support structure irreversibly deforms and relocates, thereby creating at least one overhang above at least one region of the support structure, said at least one overhang of the plastic material when hardened after the local heating is discarded affixing the support structure to the plastic substrate;
(iii) providing a clamping member configured to be mountable onto the gemstone, and to be shiftable from its one low potential energy state into its other low potential energy state through intermediate energy states; forming a recess in the substrate configured to receive therein the gemstone with the clamping member mounted thereon while in said one low potential energy state; shifting the clamping member towards its other low potential state thereby causing the clamping member to be stopped, by the gemstone inserted in the recess, in the intermediate energy state before reaching said other low potential energy state, and to be thereby kept by tension in said recess, thereby affixing the gemstone to said recess.

It should be noted that the methods defined by steps (i) and (ii) above may be implemented either using a pre-prepared recess in the card or not. It should also be noted that the method defined by steps (i) and (ii) may be implemented using direct application of heat (and preferably mechanical pressure) to the plastic material in the vicinity of the gemstone, via heat transfer to the plastic material from the gemstone, via a support structure carrying the gemstone that is heated and mechanically pressed, or via a separate heat-conductive element located adjacent to the gemstone that is heated (and preferably mechanically pressed). Additionally, the application of heat (and mechanical pressure) to the plastic material may be implemented by directly applying heat (and mechanical pressure) to both the plastic material and the gemstone-support structure; as well as both to the heat conductive element located adjacent to the gemstone and to the plastic material in the vicinity thereof.

The present invention also provides a method for marking by gemstone(s) an item (e.g., identification card) to present an added value to the item associated with at least one of the item provider, the item holder, and the gemstone provider. The present invention provides an opportunity for credit card providers to use diamonds and/or gemstones to create an original and unique design for new high class, top tier elite credit cards (e.g., aimed at the lucrative segments of highly rich individuals). The “gemstone/diamond card” of the present invention will present credit card providers with innovative and highly competitive features. By “gemstone/diamond cards” is meant here a card designed by the techniques of the present invention and containing, diamonds, or gemstones or both, defining a certain pattern. Such a card is a new, top tier, high-class credit card, replacing current high-class cards like “Platinum” or “black” cards, which are aimed at the top tier of richest and highest spending credit card customers (like top 1% of customers); the current high level cards having slowly lost their glamour and “mystique” by becoming increasingly too widespread and common, there is a need in the market for a new and special type of top tier, high class card. Therefore a gemstone/diamond card will be welcomed and will differentiate its holder from other previous top tier card holders. Therefore, the new card provided by the technique of the present invention will attract new members to the gemstone/diamond card provider at the expense of competitors, thus providing added revenues to the gemstone/diamond card provider. Additional revenues will be also generated as such rich individuals or groups of individuals can be targeted with higher priced promotional programs. To the user (card holder), this card is beneficial, by providing him with a unique status symbol and special advantageous purchasing and other business opportunities offered only to the specific niche of gemstone/diamond card holders by the card provider. To the gemstone/diamond provider, the present invention provides new promotional opportunities, aimed at the top tier niche, by inscribing its trade name(s) and/or brand name(s) and/or logo on the card, or by adding, by the card provider, promotional brochures, guarantee certificates, coupons, discounts, earning points on purchases, and such other promotional material aimed at increasing awareness to the gemstone/diamond provider towards purchasing of diamond/gemstone jewels from the gemstone/diamond provider or from one of its distributors, such as a jeweler. This will provide additional revenues for the gemstone/diamond provider.

Thus according to yet another broad aspect of the invention, there is provided a method for marking an item to provide an added value to at least one of an item provider, an item holder and a gemstone provider, the method comprising: providing at least a part of the item in the form of a carrier of a pattern formed by a plurality of gemstones arranged such that at least a part of each gemstone is directly exposed to a viewer.

The present invention, in yet another aspect, provides a processing tool for use in affixing a gemstone in a plastic substrate, the tool being designed to apply heat to a material brought in contact with the tool, the tool being configured to define a plurality of protrusions arranged in a spaced-apart relationship along a predetermined curve, each protrusion for contacting the corresponding one of a contacting regions of the material.

The material to be contacted by the processing tool may be a plastic material of a substrate (e.g., ID card), or a separate heat conductive element, e.g., the gemstone to be affixed to the plastic substrate. The tool is preferably designed to apply both heat and mechanical pressure to the plastic material, for example the specific weight of the tool can be made so as to be sufficient for the mechanical pressure needed together with the heat application.

According to a further broad aspect of the present invention, there is provided a clamping member for use in attaching an object to a recess made in a plastic substrate of a carrier, the clamping member being a spring, configured to be mountable onto the object and to be shiftable from its one low potential energy state to the other low potential energy state though its intermediate energy states.

### BRIEF DESCRIPTION OF THE DRAWINGS

In order to understand the invention and to see how it may be carried out in practice, specific embodiments will now be described, by way of non-limiting examples only, with reference to the accompanying drawings, in which:—

FIG. 1 illustrates a typical polished diamond (round “brilliant” cut) design showing its various main parts;

FIG. 2A is an example of a plastic card (an identification card) configured according to the invention;

FIG. 2B is an example of a plastic card (an identification card) configured according to the invention;

FIGS. 3A to 3D show one example of a method of the present invention for embedding gemstones in a plastic card by applying local heating and mechanical pressure directly to the gemstone, thereby transferring heat to a region of the plastic substrate in the vicinity of the gemstone;

FIGS. 4A to 4C show another example of a method of the present invention for embedding indented gemstones in a plastic card by applying local heat and mechanical pressure directly to the gemstone, thereby transferring heat to a region of the plastic material in the vicinity of the gemstone;

FIGS. 5A to 5D show yet another example of a method of the invention for embedding gemstones in a plastic card by applying local heat and mechanical pressure directly to a region of the plastic substrate of the card in the vicinity of the gemstone;

FIGS. 6A to 6C show an example of a method of the invention for embedding gemstones in a plastic card by indirectly applying local heat and mechanical pressure to a region of the plastic material of the card in the vicinity of the gemstone, via a separate heat-conductive element located on the gemstone;

FIGS. 7A to 7C show another example of a method of the invention for embedding gemstones in a plastic card by indirectly applying local heat and mechanical pressure to a region of the plastic material of the card in the vicinity of the gemstone, via a separate heat-conductive element located independently around the gemstone;

FIGS. 8A to 8D show yet another embodiment of the invention for manufacturing a gemstone-patterned carrier using a gemstone's support structure on which the gemstones are mounted in a conventional manner used is jewelry, and attaching this support structure to a plastic substrate by the application of heat; and

FIGS. 9A to 9H show yet another example of a method of the invention for embedding a gemstone in a plastic card by using a clamping member of the present invention.

### DETAILED DESCRIPTION OF THE DRAWINGS

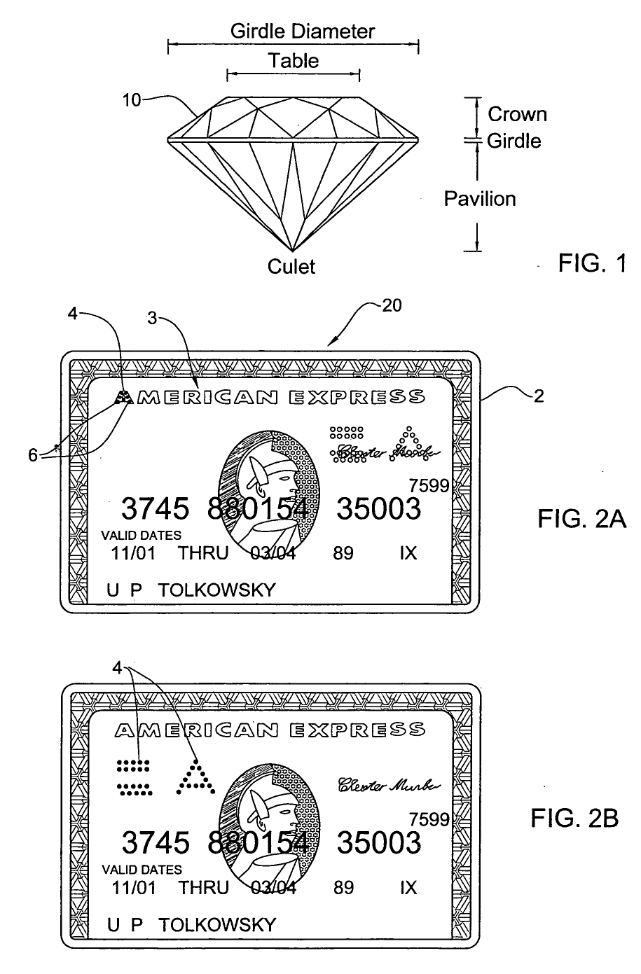

FIG. 1 exemplifies a typical polished diamond 10 (round “brilliant” cut) suitable to be used in the present invention. The diamond 10 has such main parts as table, crown, girdle, pavilion, and culet.

The present invention provides for embedding a plurality (i.e., group, matrix or cluster) of gemstones, preferably diamonds of FIG. 1, in a carrier while being arranged in accordance with a certain pattern, associated with the carrier provider and/or carrier the holder and/or the gemstone provider.

It should be noted that the gemstone-carrier of the present invention may be a certain item (e.g., ID card, such as a credit card; compact disk; pen; etc.) or being intended to be attachable to a certain item (e.g., an electronic device, such a cellular phone, watch, etc). More specifically, the present invention is used with identification cards and credit cards and is therefore described below with respect to this specific application, being however not limited thereto, as well as to carriers made of thermoplastic material. It should also be noted that although the illustrations and descriptions presented herein relate to ideal round brilliant cut diamonds as these allow clear, concise, and unambiguous terminology, diamonds and other gemstones suitable to be used in the present invention may have various shapes and may have various cuts, for example with or without table and/or crown and/or pavilion (even at the expense of brilliance).

Referring to FIGS. 2A and 2B, there are schematically exemplified credit cards, generally designated 20 (constituting plastic cards), configured according to the present invention to provide added value by inscribing with diamonds at least one certain mark associated with at least one of the credit card provider, credit card holder and gemstone provider. In these examples, an American Express® credit card is shown, but it should be understood that the principles of the present invention may be utilized in a credit card related to any other credit card provider, e.g., VISA®, MasterCard®, Diners Club International®, MBNA®, etc. and other types of identification cards. The new “gemstone/diamond card” of the present invention could be positioned as the new top tier American Express® (or other credit card providers), or another type of ID cards, such as Cartier Card, provided by Cartier, a renown luxury/jewelry house.

Credit card 20 presents a plastic carrier typically provided with various data fields, one of the data fields 3 being indicative of the credit card provider related data (e.g., its trade name). According to the invention, the carrier is itself a substrate, or has a substrate, carrying the gemstones-pattern. In the example of a credit card, it is a plastic substrate 2 that carries a pattern 4, which in the example of FIG. 2A is incorporated within a data field typically provided in the card, namely the data field associated with the credit card provider, and is indicative of the letter “A” (the first letter of the meaningful pattern “American Express”), formed by a plurality of gemstones (preferably diamonds) 6 embedded in the plastic material of the card.

Such a multiple-gemstone (e.g., multiple-diamond) pattern may and may not be associated with the data contained in the credit card data field. In the example of FIG. 2B, a multiple-gemstone pattern 4 is presented as a separate field. As shown in FIG. 2B, the pattern 4 is formed by two spaced-apart parallel lines, each formed by two rows of diamonds, and a letter “A”. It should be noted that a multiple-gemstone pattern may for example be arranged as a frame extending along the peripheral region of the substrate 2 or along the internal ellipse-like curve surrounding the logo at the center of the card 20.

The gemstones 6 are directly exposed to a viewer, preferably without intervening layers. The gemstones 6 are affixed to the substrate 2 by applying heat with mechanical pressure, and/or by using a specifically designed clamping member. It should, however, be noted, although not specifically shown, that generally a laminating/protecting transparent layer may be provided on the substrate containing the gemstones/diamonds.

It should be noted that the thickness h of a typical credit card is of about 0.8 mm, and therefore the use of a diamond of about 0.6 mm height and about 1.0 mm girdle diameter, as obtained with a perfect round brilliant cut, is suitable in accordance with the techniques of the invention.

The “gemstone/diamond card” of the present invention provides added value to the card provider, for example, it provides a credit card company with an innovative and highly sought after card designed to offer its top tier, richest and top spending customers with a new type of high-class card. Entitlements to this card would include potentially valuable business tie-ups between the card provider and the gemstone provider and between the card holder and the gemstone provider. For example, the gemstone provider would provide the ID card company, free of charge, with gemstones to be used in the card, provided that the trade name of the gemstone provider is made known to the card holder by the card provider. This could be done for example by inscribing the gemstone provider's trade name, brand name and/or logo on the card and/or on a special pouch holding the card, and/or by attaching to the card, when supplied to the card holder, a promotional brochure; and/or by sending from time to time promotional messages and/or other contents, coupons etc. to the card holder. As another example, the card holder could earn points, or discount, towards the purchase of diamonds with selected retailers or jewelers that are in business relationship with the gemstone provider, e.g., distributing his diamonds. The inventive credit card design incorporates gemstones (diamonds), so as to be viewed at its surface. The gemstone provider selects and supplies the needed gemstones (diamonds) to be inserted into the credit card. The diamonds could cover the logo and/or the letters of the credit card provider on the card. The “gemstone/diamond card” may be supplied to a card holder together with the diamond provider's quality guarantee certificate.

It should be understood that the entire credit card provider's name/logo or one or more selected letters/symbols/contours thereof may be presented on the card as a multiple-diamond (multiple-gemstone) pattern. It should also be understood that an identification (plastic) card of the present invention may be marked by presenting at least one letter/symbol or the entire name/logo of the card holder by a multiple-gemstone pattern. Generally speaking, a multiple-gemstone pattern may be any symbol or any other geometrical form in the data field typically used in an identification card, or an additional field within a space between the data fields. Alternatively or additionally, the multiple-gemstones pattern may be associated with a data field carrying information relating to the gemstone provider.

The present invention provides simple and cost effective techniques for embedding one or more gemstones in a plastic card in a manner that, on the one hand, exposes the majority of the upper surface of the gemstones to a viewer and, on the other hand, allows for conventional techniques for reading of the card.

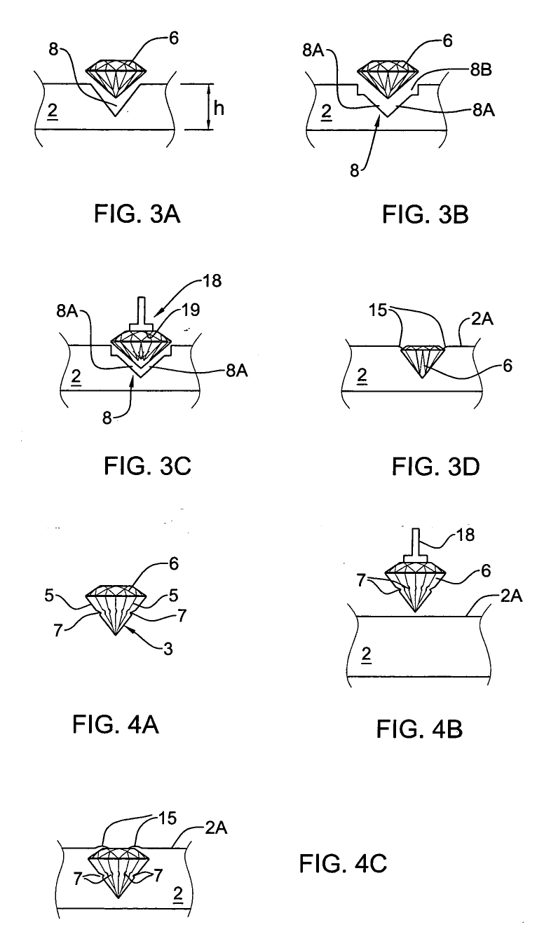

FIGS. 3A to 3D exemplify a technique of the present invention for affixing a gemstone (diamond) 6 to a plastic substrate 2 by application of heat and appropriate (slight) mechanical pressure. This example is applicable with gemstones that are heat conductive, such as diamonds. It should however be noted that generally, a non heat conductive gemstone may be used as well, provided it is heated separately to the proper temperature prior to being affixed to the card with mechanical pressure. Local heating and mechanical pressure are applied directly to the diamond 6, which transfers heat to the plastic material in the vicinity thereof thus causing softening/melting of the plastic material. As shown in the example of FIGS. 3A and 3B, the plastic substrate 2 is first formed with a predetermined number of recesses—one such recess 8 being shown in the figures, intended for carrying the diamond 6. Recesses can be made by any known suitable means, for example by drilling. It should, however, be noted that in this embodiment of the invention, where the plastic material is heated via heating and pressing the gemstone itself, the provision of pre-prepared recesses is optional. In the example of FIG. 3A, the recess 8 is of a substantially conical shape. In the example of FIG. 3B the recess 8 has a lower cone-shaped portion 8A and an upper cylindrically-shaped portion 8B of a diameter substantially equal to that of the cone base. Both the recess shape of FIG. 3A and the recess shape of FIG. 3B are suitable to receive gemstones being polished to a cut similar to a round brilliant cut, having a round conical shaped pavilion.

Considering brilliant cut (or any cut having a pavilion, crown and table) diamonds or gemstones, the recess 8 is of a conical shape corresponding to that of the pavilion of the diamond 6, but preferably of smaller dimensions (e.g. smaller by 0.2 mm from the pavilion dimensions). In this case of a round brilliant cut, the recess 8 has a conical shape of FIG. 3A, having a head angle α smaller than the culet angle of the diamond 6. The recess 8 may alternatively have a head angle equal to the culet angle of the diamond 8 and depth smaller than the height of the diamond.

In the embodiment of FIGS. 3A-3D, the recess geometry and dimensions are such as to permit accurate placement of the gemstone into the recess. Using the recess smaller than the pavilion in dimension permits, when the gemstone has been entirely introduced therein, the displacement of excesses of softened/melted plastic material, being irreversibly deformed, to relocate as an overhang above a portion of the upper surface of the gemstone.

As shown in FIG. 3C, the diamond 6 is placed into the recess 8, and a processing tool (heat applicator) 18, for example an electrical heater, is brought in contact with the upper surface of the diamond 6 (its table), so as to heat it, while simultaneously applying mechanical pressure onto the gemstone. To this end, the external contacting surface 19 of the heat applicator has dimensions equal to or slightly smaller than the diamond's table. The specific weight of the processing tool 18 can be made such as to be sufficient for the mechanical pressure needed together with the heat application.

As a result of such heating, the plastic material in the vicinity of the recess is softened/melted, irreversibly deforms, displaces around the diamond into close areas with low resistance, thus settling as an overhang 15 of the plastic material, affixing the diamond 6 into the card (to its substrate).

It should be noted that the mechanical pressure needed is low. For example, embedding diamonds in a conventional credit card according to this embodiment may be carried out at 120° C. heating and 100 g pressure.

FIG. 3D shows the results of this heating and mechanical pressing process. When the application of heat is stopped (the heat applicator is removed), the softened/melted plastic that has irreversibly deformed and settled as an overhang above the diamond, becomes hardened and the diamond is thus affixed to the card. The diamond 6 is affixed to a face 2A of the plastic substrate 2, and is held in place by the plastic overhang 15 created above the diamond's girdle, covering the crown (i.e., the portion that is close to the girdle) within the peripheral region thereof, and leaving most or all of the table, and at times part of the crown (depending among others on the diamond shape and the recess design), exposed to a viewer as to allow maximal brilliance. It should be noted that all the implementations of the gemstone embedding process of the present invention can be carried out at room temperature conditions, no dedicated cooling of the card or card environment being needed. As indicated above, the principles of the embodiment of FIGS. 3A-3C are also applicable without having a pre-drilled recess in the card: the diamond 6 is then inserted in the same manner into the card/substrate 2 by applying heat and mechanical pressure; the main difference would be to get a larger overhang 15 as opposed to using pre-drilled recesses, due to the larger quantity of displaced plastic material. Turning back to FIG. 2B, the illustrated credit card 20 was prepared by the above-described technique of FIGS. 3A-3D.

Reference is made to FIGS. 4A to 4C exemplifying a technique similar to the previous one (in FIGS. 3A-3D), wherein the pavilion of the diamond is indented in one or several regions of its pavilion (for example in the rims), affixing the diamond to the card (substrate) by the softened/melted plastic that was introduced into the indentation(s) and then hardened. Also, direct heating and pressing into the plastic material, without recurring to a recess, is exemplified here, whereas, a recess can be used, similarly as in the example of FIG. 3A-3C.

As seen in FIG. 4A, the pavilion 3 of a diamond 6 has indentations 7 previously made to rims 5. FIG. 4B shows a heat applicator 18 configured similar to the heat applicator used in the previous example, to be applied for heating and pressing the diamond 6 directly onto a surface 2A of a plastic card (substrate) 2. FIG. 4C shows the diamond 6 being embedded into the substrate 2 (with the diamond's upper surface being exposed to view), after the heat applicator 18 has been removed. The softened/melted, irreversibly deformed plastic, has repositioned itself inside the indentations 7, these indentations being of low resistance, and as an overhang 15 as in the previous example, and when hardened after the heat applicator has been removed, the diamond 6 is being affixed into the substrate 2 by the hardened plastic inside the indentations 7 and by the hardened overhang 15. In this case (using diamond's indentations), the overhang 15 may eventually be removed, so that diamond 6 is held fixed to the substrate 2 only by the hardened plastic inside the indentations 7, the entirety of the table and crown being exposed to the viewer.

This technique can also be performed with a non heat-conductive gemstone, in a similar way, provided the gemstone has been heated separately to the proper temperature prior to be inserted into the card. It should also be noted that the scale of the pressure and temperature may be the same as in the previous examples.

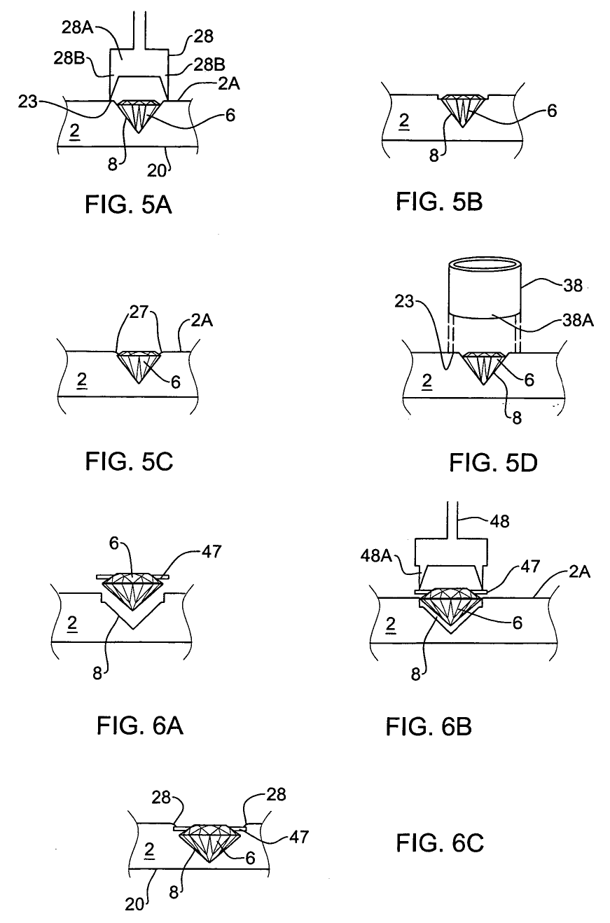

FIGS. 5A to 5D show another example of producing a gemstone carrier (e.g., an identification card) 20 of the present invention by affixing diamonds 6 to a plastic substrate 2 (which may be the entire carrier, as for example in ID cards) by local heating of the plastic material. In the present example, heat and mechanical pressure are applied directly to the plastic material of the substrate 2 in the vicinity of the diamond 6.

FIGS. 5A and 5B show the plastic substrate 2 formed with a recess 8 of a conical shape (FIG. 5A) or cone with cylinder shape (FIG. 5B) carrying the diamond 6 completely located in the recess 8. A heat applicator 28 is configured to define contacting region(s) to contact region 23 on the upper surface 2A of the substrate 2 in the vicinity of the recess 8 (i.e., in the vicinity of the diamond located in the recess). The heat applicator may be configured to define several (generally at least two) spaced-apart contacting regions, or a continuous contacting area, similar to a continuous circular contacting area (as will be described below). For example, for a round diamond of 1 mm diameter, the contact region(s) 23 on the substrate 2 may be located at a distance of 0.2 mm outside of the recess perimeter. In the present example, the heat applicator 28 is a rod-like member 28A formed with a plurality of protrusions 28B (preferably, at least four protrusions arranged in a circular array preferably being equally spaced from each other) for contacting the corresponding plurality of locations (points) along the annular region 23 of the upper surface 2A of the substrate 2 surrounding the recess 8.

Application of heat and mechanical pressure results in softening/melting of the plastic material within the contact region 23. This softened/melted plastic irreversibly hardens and repositions itself towards the recess, being the lowest resistance zone, creating overhang 27 covering the crown of the diamond 6, as shown in FIG. 5C. Due to the provision of the recess (hole) 8 made in the plastic material, heating of the plastic material (either directly, or via a separate heat conductor as will be described below) causes the softened/melted plastic to irreversibly deform and shift towards the recess, said recess being a close by low resistance area. As a result, the diamond 6 is embedded into the plastic material, overhang 27 at the contact region 23 covers the crown of the diamond 6, while leaving most or the entire table and at times also part of the crown (depending among others on the diamond shape, as well as on the recess design, which influences the quantity of material that will settle as overhang) exposed to a viewer. The diamond is held fast in place by the overhang, whereby the plastic material composing the overhang is hardened after the heater is removed.

As indicated above, heat (together with mechanical pressure) is preferably applied in several points of the plastic surface to better attach the diamond to the card, wherein such several points are either arranged in a spaced-apart relationship along a closed contour or are arranged to form a continuous circular contour.

FIG. 5D exemplifies the use of a heat applicator 38 configured to define a continuous circular contacting region 38A. The heat applicator 38 has a tubular portion thereof (by which it contacts the card/substrate) of a diameter slightly larger than the cone base (or upper cylinder) of the recess 8, so as to bring the lower surface 38A of the tube in contact with region 23 of the card surrounding the recess 8. For example, for a recess having a cone base diameter of 1.1 mm, the inner diameter of the tubular portion 38A may be of 1.3 mm. As indicated above, the pressure needed is low. For example, embedding diamonds in a conventional credit card may be carried out at 120° C. heating and 100 g pressure.

It should be noted that the techniques exemplified in FIGS. 3A-3D, 4A-4C and 5A-5D may be combined, namely, heat and pressure may be applied to both the diamond and the plastic material region in the vicinity thereof, or heat may be applied to both of these elements, while pressure is applied to the diamond. In all these cases, the scale of the temperature and pressure may be the same as noted above.

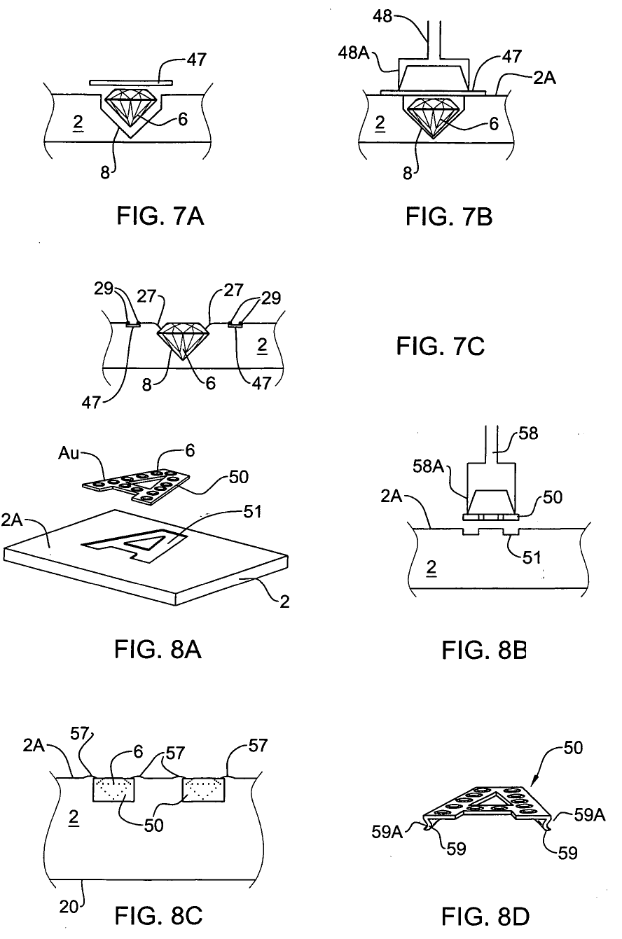

The present invention also provides for affixing a gemstone to a plastic substrate (e.g., card) by applying heat, together with mechanical pressure, to the plastic material via a separate heat conductive element, which remains in the card together with the gemstone when the gemstone affixing process is completed. This is exemplified in FIGS. 6A-6C and FIGS. 7A-7D.

FIGS. 6A-6C exemplify the case when a heat-conductive element is configured such that, when embedded by heat into the carrier's substrate, it affixes the diamond to the carrier. As shown in FIG. 6A, a plastic carrier (e.g., credit card) is formed with a required number of recesses—one such recess 8 being shown in the figure. The recess 8 has a cone (or cone-with-cylinder) shape, of a size suitable for receiving therein the diamond's pavilion, and the depth of the recess is approximately the height of the diamond. The diamond 6 is placed in the recess 8 (FIG. 6B). A heat-conductive ring-like element 47, for example a metal ring, is then placed above the diamond (as such, and for simplicity of description, the heat-conductive element will be called hereinafter a “ring”). The ring 47 has an inner diameter smaller than the girdle diameter of a diamond 6 (so that if mounted on the crown of diamond 6, it is supported by this crown). The outer diameter of the ring 47 is larger than the recess diameter, so that the ring initially lies on the upper surface 2A of the substrate 2 surrounding the recess 8, in which the diamond has been deposed. Heat and mechanical pressure are applied to the ring 47 from a processing tool 48 (that can be configured as an applicator of an appropriate weight to provide the required mechanical pressure). The processing tool 48 may for example be configured similar to the above-described heat applicator 28, namely having an array of spaced-apart contacting members 48A for contacting the ring 47 in spaced-apart regions. Heating these spaced-apart contacting regions of the ring 47 results in the entire ring 47 being heated. Such heating, together with pressing the ring 47, causes softening/melting of the plastic material of the carrier in the vicinity of the ring 47. The heat applicator 48 may then be removed, leaving the ring embedded in the plastic substrate, being held in place by overhangs 28. These overhangs are produced by softened/melted plastic that irreversibly deforms and shifts so as to settle above the outer perimeter of the ring, being a close by low resistance zone, and subsequently hardened after the heat applicator is removed, holding fast the outer perimeter of the ring (the diamond 6 being held fast by the inner perimeter of the ring 47 that lying on the crown, having dimensions smaller than the diamond girdle). The affixed ring 47 holds fast the diamond at its crown by its inner perimeter (as its diameter is smaller than the girdle's diameter). Thus, the diamond 6 and the encircling ring 47, are inserted and affixed in the carrier 20 FIG. 6C shows a carrier 20 resulting from such a local heating applied indirectly thereto, i.e., via the heat-conductive element 47.

It should be noted that this process could be done also without a pre-prepared recess. The diamond 6 and the heat-conductive element 47 are then inserted in the same manner into the substrate 2 by applying heat and mechanical pressure; the main difference is in getting larger overhangs as compared to those obtained when using a pre-drilled recess, due to the larger quantity of displaced softened/melted plastic material. In this case, a non-heat-conductive gemstone can also be used, provided it is first separately heated to the proper temperature, and then inserted while hot into the plastic material. The element 47 can also be made of a non heat-conductive material, provided it is first separately heated to the proper temperature, and then inserted while hot into the plastic material.

It should be noted that the needed pressure is low. For example, embedding diamonds in a conventional credit card may be carried out at 120° C. heating and 100 g pressure.

Regarding the heating element (ring) dimensions, e.g., for a diamond having a girdle diameter of 1 mm, inserted in a recess of 1.1 mm, the ring's inner diameter may be of 0.8 mm and the outer diameter 1.3 mm.

It should be also noted that a pattern of several diamonds can be embedded in a plastic substrate using a single heat-conducting element, using the technique described above. In this case, the heat conducting element is shaped according to the required diamond pattern and has several openings (holes) at the predefined locations for the diamonds, each having a diameter smaller than the corresponding diamond girdle.

FIGS. 7A-7C exemplify the case when a heat-conductive element (such as a metal ring, as in the previous example) is initially placed on the surface of a carrier (substrate) so as to surround a recess containing a diamond, and the heat-conductive element is heated and pressed so as to be embedded in the plastic carrier. As shown in FIG. 7A, a plastic substrate 2 is formed with a recess 8 shaped for receiving a diamond 6. The diamond 6 is placed in the recess 8, and a heat-conductive ring 47 of an inner diameter larger than that of the recess diameter is placed on the surface 2A of the plastic substrate 2 so as to surround the recess 8, and then, a heat applicator 47 is applied to spaced-apart regions of the ring 47 (FIG. 7B). For example, for a recess of a diameter of 1.1 mm, the inner diameter of the heat conductive ring 47 may be of 1.3 mm, and the outer diameter of 1.8 mm. The application of heat with mechanical pressure onto the ring 47 results in softening/melting of the plastic material in the vicinity of the ring 47 thus irreversibly deforming the plastic, embedding the ring 47 in the substrate and creating overhangs 29 above the outer and inner perimeters of the ring 47, affixing it to the substrate when the plastic material within the overhangs 29 is hardened after the heater is removed. The introduction of the ring 47 causes the softened/melted plastic to run also towards the recess (both, the regions above the outer and inner peripheries of the ring and the recess are close by low resistance zones, into which the softened/melted plastic relocates), producing an overhang 27 above the diamond crown, that when hardened after the heater is removed, affixes the diamond 47 to the recess 8 (FIG. 7C). It should be noted that the mechanical pressure needed is low, e.g., diamonds may be embedded in the conventional credit card by using 120° C. heating and 100 g pressure.

It should be noted that this process can be done also without a pre-prepared recess. The diamond 6 and the heat conductive element 47 are then inserted in the same manner into the plastic substrate 2 by applying heat and mechanical pressure; the main difference is in getting a larger size of the overhang 27 above the diamond's periphery as compared to the case of using a pre-drilled recess, due to the larger quantity of displaced softened/melted plastic material. In this case, a non heat-conductive gemstone can also be used, provided it is first separately heated to the proper temperature, and then inserted while hot into the plastic material. The element 47 can also be made of a non heat-conductive material, provided it is first separately heated to the proper temperature, and then inserted while hot into the plastic material.

It should also be noted, although not specifically shown, that embedding a gemstone in a recess made in a plastic carrier may be performed via a heat-conductive material in the form of a coating on an inner surface of the recess prepared prior to inserting the gemstone in the recess.

FIGS. 8A-8D exemplify yet another embodiment of the invention, where a gemstone-patterned carrier of the present invention is formed using a support structure on which the gemstones are mounted in a conventional manner used is jewelry, and attaching this support structure to a plastic substrate. Here, the support structure is made out of a heat-conductive material, preferably gold or silver (as used customarily in jewelry), in which diamonds have been earlier set by one of the conventional techniques used in jewelry; and the support structure with gemstones thereon, is inserted by heat and pressure into a plastic substrate (e.g., ID card) and affixed thereto by overhangs.

FIG. 8A shows a support structure 50 in the form of a sheet of gold (Au) carrying the gemstone pattern arranged into the letter “A”. In the present example, this gemstone pattern of letter “A” is achieved by shaping the support structure 50 as letter “A”, wherein a plurality of diamonds 6 have previously been set so as to be aligned along the support structure 50, so that they follow/create the same pattern of “A”. It should however be understood that the support structure 50 may be configured not according to the gemstone pattern, but as a rectangular or circular Au plate (or any other shape), while the gemstones thereon being arranged in accordance with a desired pattern. A recess 51 is made (for example by cutting) in a plastic substrate 2, whereby the recess has the shape of the support structure 50, but is slightly smaller in width or in depth. For example, if the support structure 50 is 7 mm high and 5 mm wide, each segment of the recess may be 0.4 mm smaller than the respective segment of support structure 50 while the depth of the recess 51 remains the same as the thickness of the support structure 50.

FIG. 8B shows a heat applicator 58 configured for heating and mechanically pressing the support structure 50 into the recess 51. Heat applicator 58 may for example be configured similar to the above-described heat applicator 28, namely having an array of spaced-apart contacting regions 58A for contacting the support structure 50 in spaced-apart locations where no diamond is set. Heating these spaced-apart contacting regions of the support structure 50 results in the entire support structure 50 being heated. Such heating, together with mechanically pressing of support structure 50, causes softening/melting of the plastic material of the substrate 2 in the vicinity of support structure 50. The heat applicator 58 may then be removed, leaving the support structure 50 embedded in the plastic substrate being held in place by overhangs 57, such that the diamond-pattern is exposed to view. These overhangs 57 are produced by softened/melted plastic that irreversibly deforms and is shifted so as to settle above the outer perimeter of support structure 50, being a close by low resistance zone, and subsequently hardened after the heat applicator 58 is removed, holding fast the outer perimeter of the support structure 50. FIG. 6C shows a cross section of the carrier after the heat applicator 58 has been removed and the overhangs 57 have been cooled off and hardened as explained above. The support structure 50 is thus affixed to the substrate 2 resulting in a gemstone-patterned carrier 20.

It should be noted that this process can be done also without a pre-prepared recess. The support structure 50 is then inserted in the same manner directly onto the surface 2A of the plastic substrate 2 by applying heat and mechanical pressure; the main difference is in getting larger overhangs 57 due to the larger quantity of displaced softened/melted plastic material.

Also in this case, a heat-conductive or non heat-conductive support structure 50 can be used as described above with respect to the gemstone and the separate element. It should also be noted that the heat conductive gemstone, element or support structure may be first separately heated to the proper temperature and then inserted while hot into the plastic material.

It should be noted that the support structure 50 can be shaped so as to define a pattern of grooves and protrusions on its lower surface or within its periphery so as to provide a relocation space for the softened/melted plastic material. This is exemplified in FIG. 8D, showing a support structure 50 configured to define a gemstone pattern as described above and also having curved protrusions 59. In this case, although not specifically shown, in addition to the overhangs 57 that are produced as explained above, part of the softened/melted irreversibly deformed plastic will fill an inside-curved shape 59A (similar shapes being formed around the entire perimeter of support structure 50) so that when the plastic is hardened after a heat applicator has been removed, it envelops the protrusions 59 so as to affix the support structure 50 to the plastic substrate 2. Eventually, the overhangs 57 may then be cut off, so that the support structure 50 remains affixed by the hardened plastic enveloping the protrusion part 59.

It should be noted that, although the above-described examples refer to affixing the gemstone pattern to a thermoplastic carrier (substrate), the present invention is not limited to this implementation. The use of a thermoplastic carrier is suitable for most of the ID cards used today. The invention, however, deals with items, being by themselves a carrier of a multiple-gemstone pattern, in the case of ID cards for example, or being attached with such a carrier, for the purposes of presenting a certain added value to the item provider and/or item holder and/or gemstone provider. The carrier is formed by directly patterning it (embedding therein or in its substrate) by a multiple-gemstone pattern, as in the case of thermoplastic substrate for example, or by attaching to a substrate a support structure of other materials with a multiple-gemstone pattern using any other suitable known techniques.

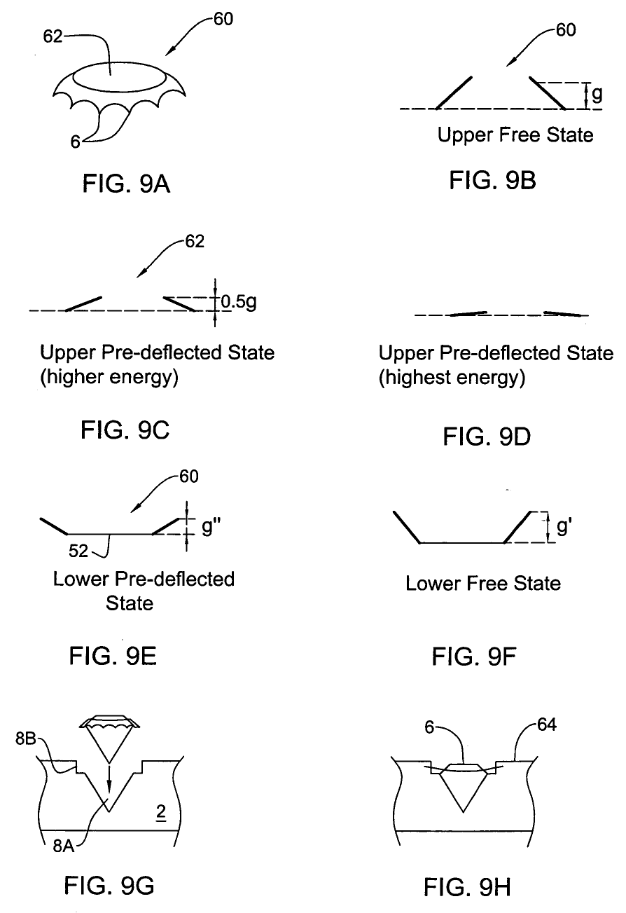

Reference is now made to FIGS. 9A-9H showing yet another embodiment of the invention, according to which a gemstone (e.g., diamond) is embedded into a plastic carrier/substrate (e.g., ID card) using a specifically designed clamping member 60. The latter is configured utilizing the principles of a (coned) Belleville Spring, known in the art of the mechanical industry as a piece of steel with high tensile strength (also called “disc spring” and “conical compression washer”). The clamping member 60 is designed to define its inner diameter 62 of dimensions allowing mounting it onto the crown of a brilliant cut diamond, thus smaller (e.g. by 0.2 mm) than the girdle of the brilliant cut diamond. It should be noted that other cut types may also be used. It is then enough to have the inner diameter of the clamping member smaller than the largest diameter on the observer-oriented side of the diamond/gemstone. The outer (larger) diameter of the clamping member 60 is larger than the girdle and made out of sharp spikes 64. For example, for a diamond having a girdle of 1 mm diameter, the inner diameter 62 of the clamping member may be 0.8 mm and the outer diameter (containing the spikes 64) may be 1.6 mm.

As shown in FIGS. 9A-9F, the clamping member 60 is especially modified according to the invention to have two low potential energy states (FIGS. 9B and 9F), called here “free states”, so that it can flip between them through intermediate energy states, called “pre-deflected states”—three of such states being illustrated in FIGS. 9C-9E. As shown in FIGS. 9A-9B, the clamping member 60 is originally in one of its two lowest energy states, being in its original conical shape, or the so-called “upper free state”. When deflected under force into a flat position, the spring 60 is loaded into a higher energy state (FIG. 9C), reaching its highest energy state as it is almost flat (FIG. 9D), the so-called “upper pre-deflected state” (or “higher energy state”). When pushed further, the spring 60 passes to “lower pre-deflection states” (FIG. 9E) by flipping into the opposite (conical) direction, while it loses energy again, until it reaches its second lowest energy state, the “lower free state” (FIG. 9F). When the spring 60 is at a “lower pre-deflected state”, while retaining a certain energy, the height g″ of the spring-cone is smaller than g′, the height of the spring-cone at the lower free state (FIG. 9F), in which the spring would have lost all its energy.

In this embodiment, a recess made in the plastic material of the carrier is designed so as to receive therein the diamond with the clamping member mounted thereon (alternatively, the diamond can be inserted first into the recess, and the clamping member laid subsequently upon it), while in the upper low potential energy state of the clamping member, and allowing the clamping member to be kept by tension in the recess while in its intermediate energy state, the so-called “lower pre-deflected state”.

As exemplified in FIG. 9G, a recess 8 in a plastic substrate 2 is configured to define a lower cone-shaped portion 8A and upon it, a cylindrical portion 8B. The cone-shaped portion 8A has dimensions equal to or larger than the pavilion of the diamond 6 (e.g., larger by 0.1 mm). The cylindrical portion 8B has a diameter larger than that of the cone 8A (e.g., by an additional 0.3 to 0.5 mm for a recess having an upper diameter of 1.1 mm), and substantially equal to the outer diameter of the spring 50 while in its original upper free state (FIG. 9B). The diamond 6 is introduced into the recess 8. The spring 60, in its original upper free state, is then freely laid upon the horizontal basis of the upper cylindrical portion 8B of the recess.

The spring 60 is then pushed by force so as to flip over to the other direction, going through a flattening, highest energy state, and then bending onto the opposite direction. When flattening, while its energy state increases, the outer diameter of the spring 60, containing the spikes 64, increases enough to penetrate the softer plastic vertical walls of the upper cylindrical recess. The inner perimeter 52 of the spring 50, is smaller than the girdle, and thus the spring is stopped, before reaching its lower free state as in FIG. 9F, by the table or preferably by the crown of the diamond 6 while in a lower pre-deflected state as in FIG. 9E, thus keeping a continuous residual pressure on the diamond. Returning to FIG. 9F, the spring is kept at a height g″ maintaining a residual pressure. In this way, the diamond is kept fast in the plastic card (in the recess made in the carrier) and most of or the entire table and at times part of the crown (depending among others on the spring design and on the diamond cut) are directly exposed to the viewer (FIG. 9H).

The outer (upper) surface of the spring 60 may be gold plated, so as to add a “luxury/jewelry”-like look.

Thus, the present invention provides simple and cost effective techniques for marking an item (e.g., a plastic card) by a certain pattern of gemstones/diamonds affixed to a carrier (which is the item itself, part of the item, or is attached to the item) in a manner to expose the pattern to a viewer. The novel item/carrier of the present invention provides added value to the item provider and/or item holder and/or gemstone provider.

The technique of the present invention provides a competitive added value for the item provider (e.g., an ID card provider, more specifically a credit card provider), as compared to other item providers. Considering the case of credit card, the novel card of the present invention may include a meaningful pattern like the trade name of the credit card provider or the name of the credit card holder, being formed partly or fully, by embedded diamonds in the card. The credit card provider will issue the new “highest-class” gemstone/diamond-embedded card (“gemstone/diamond card”) as opposed to current “high-class” cards, such as “Platinum” or “black” cards. These current “high-class” cards all started aiming at the top tier and top spending customers but slowly lost their glamour by becoming increasingly widespread and common. Thus, by positioning the gemstone/diamond cards of the present invention at an even “higher-class” than the actual “high-class”, top tier cards, and by proposing them only to the lucrative segment of carefully sorted out and categorized rich individuals or a group of individuals (such as a organization or a company), the diamond-credit card provider will have, by this new gemstone/diamond card, a “killer article” against competitive card providers. As diamonds are known to be an article of glamour, luxury and romance, such gemstone/diamond cards will be highly demanded and viewed as a sign of status and importance by their holders, when paying with them or showing them around. The term “high-class” refers to the top of the line credit card, or represents a segment of individuals (and/or group of individuals) being, among other, top spending and/or rich and/or socially important and/or high ranking and/or influential.

Diamonds being viewed as one of the most romantic existing articles, such items (e.g., cards) will be highly demanded, and well paid for, by an individual willing to offer them, for example, as a present, to his wife, daughter or grand-daughter, at such events as an anniversary, wedding day or any other occasion, possibly with an invitation to buy a diamond-jewel, using the gemstone/diamond card, at a jewelry store (that preferably has business relations with the gemstone-supplier of the card, whereby the diamonds are supplied by him). Such present-cards could have a pre-specified credit line at stores such as a jewelry store, for example, to buy an article, such jewels or gemstones.

Embedding the diamonds in a pattern of the name or initials of the item (e.g., ID card) holder, may provide a specially effective personalized feature, highly demanded by part of this top-tier segment

The gemstone/diamond item provider may use focused targeted promotional campaigns aimed specifically to catch such lucrative, rich and “big spending” individuals, using the above mentioned, and other, marketing advantages of the gemstone/diamond item.

The above examples will cause an increase in demand for these items (e.g., credit cards) by similar top tier individuals, some of them becoming new customers of the gemstone/diamond card provider, at the expense of competitive credit card providers. This new customer base, as well as the existing customer base (being composed of existing customers), both being recognized by the gemstone/diamond card provider as belonging to the targeted high-class segment of rich individuals, and to which the gemstone/diamond card will be proposed and to which then, partly or fully, these cards will be issued depending upon their interest, will get new and special promotional programs causing them to effectuate more purchases, thus spending more money with these cards than they did with previous cards=(e.g. “buy a new Ferrari car with a special discount, using your exclusive gemstone/diamond card”).

The increase in customers exercising credit through these cards, the fact that the aimed customers usually spend more money than “normal” customers, and the targeted high value promotional programs, will be the origin for larger revenues for the gemstone/diamond card provider.

Other types of card providers will experience similar added value. Although diamonds were given here as an example, it should be understood that similar added values can be obtained with other types of gemstones. Another added value to the card-provider is a promotional effect towards potential top-tier, rich card-owners, being the only company to have such exclusive, high-class card.

Another source of promotional added value for the card-provider occurs when, after their expiration, these cards, by their beauty and rareness (being distributed only to selected, top spending individuals), they will become a highly demanded, collector's item, like “objets d'art”.

A direct revenue added value for the card-provider occurs when a merchant, wholesaler, retailer or any type of vendor, for example a jeweler or another type of retailer of gemstones sells such special gemstone/diamond cards to rich clients, wherein the card has a certain credit line to purchase gemstones/diamonds and/or jewelry by a third person. The trade-name or logo of the jeweler may be inscribed, for example, with gemstones/diamonds, or preferably the name of the third person to which this card is offered as a present may be similarly inscribed. Diamonds and gemstones being highly regarded romantic articles, such a card may be purchased by a person to offer as a present to his wife, daughter, granddaughter, etc, on the occasion of a birthday, wedding day or any other event. This will produce increase in sales by the jeweler, leading to increase in revenues.

The added values for the card provider, turning into increased revenues, will be achieved with low production costs of these cards, due to the fact that the diamonds could be provided free of charge by the gemstone provider against promotional benefits towards such top-tier, high-class customers, and due to the relatively low cost of the diamond insertion techniques of this invention.

The present invention provides an added value of status for the card holder, as it allows him to position himself at a high social status versus his entourage, while using or showing off this card among them. Also, it can provide him with various marketing benefits aimed only at holders of these specific types of cards.

Another added value to the card-holders is that by becoming collector's items, normally after their expiration, these cards will become a source of revenue for the card-holder.

The invention also provides added value to the gemstone provider in the form of added promotion and/or, revenues being the exclusive supplier to the gemstone/diamond card provider of the gemstones to be inserted in the cards. The gemstones/diamonds could be sold to the gemstone/diamond card provider, thus increasing the revenues of the gemstone provider. The gemstones/diamonds could alternatively be supplied free of charge, in return that the card provider will promote the gemstone provider's name, trade name, logo, etc, to the card holder. This can be done for example, by inscribing the gemstone/diamond provider's brand name (and/or trade name) and/or logo on the card, and/or by attaching to the card, when it is sent to the card holder, a promotional brochure; and/or by sending from time to time promotional messages to the card holder. Also, the card holder could earn points, or discount, towards the purchase of diamonds with selected retailers or jewelers that are in a business relationship with the gemstone provider, e.g., selling and/or distributing his gemstones/diamonds. Following such and other promotional programs to gemstone/diamond card holders, such card holders will purchase gemstones or jewelry containing gemstones from the gemstone provider or from said selected jewelers or distributors or other parties that are in business relationship with the gemstone provider, thus selling his gemstones, being for example set in their jewelry pieces. This will ultimately generate additional sales to the gemstone provider, thus creating an increase in revenues. The gemstone/diamond card may be supplied to a card holder as a gemstone/diamond provider's quality guarantee certificate or together with such a certificate. These promotional opportunities for the gemstone provider, will lead towards increase in business of a new, lucrative segment of the very rich individuals. Other parties in the supply chain would also benefit from these new businesses, like the gemstone provider's distributors, jewelers that are working with him, etc.

Another promotional added value for the gemstone provider is attained when the card becomes a collector's item, normally after their expiration, and when the name/logo of the diamond/gemstone provider are inscribed in the card.

Those skilled in the art will readily appreciate that various modifications and changes may be applied to the embodiments of the invention as hereinbefore described without departing from its scope defined in and by the appended claims.

1. A carrier associated with a certain item, the carrier having a pattern formed by a plurality of gemstones affixed to the carrier with at least part of each gemstone being directly exposed to view.

2. A carrier according to claim 1, comprising a substrate having said pattern embedded therein with the at least part of each gemstone being directly exposed to view.

3. A carrier according to claim 2, wherein said substrate is made of a thermoplastic material.

4. A carrier according to claim 3, configured as an identification card.

5. A carrier according to claim 3, configured as a credit card.

6. A carrier according to claim 1, comprising a substrate; and a support structure having said pattern and being affixed to said substrate.

7. A carrier according to claim 6, wherein said substrate is shaped according to the pattern, the gemstones being embedded in the material of the substrate along the substrate.

8. A carrier according to claim 6, wherein said substrate is a part of the item.

9. A carrier according to claim 8, wherein said item is an electronic device.

10. A carrier according to claim 9, wherein said electronic device is at least one of the following: a phone device, and a watch.

11. A carrier according to claim 8, wherein said item is a compact disk.

12. A carrier according to claim 1, wherein said pattern is meaningful.

13. A carrier according to claim 1, wherein said pattern presents at least a part of a data field presented on the item.

14. A carrier according to claim 1, said pattern is located within a space between data fields presented on the item.

15. A carrier according to claim 1, wherein said pattern is indicative of a symbol, letter, or logo.

16. A carrier according to claim 1, wherein said pattern is configured as a certain geometric form.

17. A carrier according to claim 1, wherein said pattern is configured to be indicative of at least one of an item provider, an item holder and a provider of the gemstones forming the pattern.

18. A carrier according to claim 1, wherein said gemstones include at least one diamond.

19. A carrier according to claim 18, wherein the diamond is a polished diamond.

20. A carrier according to claim 19, wherein the diamond is polished into a brilliant cut diamond.

21. A carrier according to claim 1, wherein said gemstones are diamonds.

22. A carrier according to claim 21, wherein said diamonds are polished diamonds.

23. A carrier according to claim 22, wherein the diamonds are polished into brilliant cut diamonds.

24. A carrier according to claim 1, wherein said gemstones are affixed to the carrier to be exposed to view, without intervening layers.

25. A carrier according to claim 1, wherein an upper surface of the carrier comprises a transparent protective layer structure, said gemstones being exposed to view through said layer structure.

26. A carrier according to claim 1, wherein the gemstones are affixed to the carrier so as not to protrude from the carrier.

27. A carrier according to claim 3, wherein an upper surface of the gemstone by which it is exposed to view has at least one region covered by the plastic material of the substrate, being thereby affixed to the carrier.

28. A carrier according to claim 6, wherein an upper surface of the support structure by which it is exposed to view has at least one region covered by the plastic material of the substrate, being thereby affixed to the substrate.

29. A carrier according to claim 3, wherein each of the gemstones is located within a recess made in the substrate.

30. A carrier according to claim 6, wherein the support structure is located in a recess made in the substrate.

31. A carrier according to claim 27, wherein each of the gemstones is located within a recess pre-prepared in the substrate.

32. A carrier according to claim 28, wherein the support structure is located within a recess pre-prepared in the substrate.

33. A carrier according to claim 27, wherein said at least one region of the plastic material is produced by applying appropriate heat to the plastic material of the substrate in the vicinity of the gemstone, and applying appropriate mechanical pressure; thereby causing softening/melting of the plastic material, that becomes irreversibly deformed and relocates as an overhang above the gemstone, which when hardened after the local heating is discarded, affixes the gemstone to the substrate.

34. A carrier according to claim 28, wherein said at least one region of the plastic material is produced by applying appropriate heat to the plastic material of the substrate in the vicinity of the support structure, and applying appropriate mechanical pressure; thereby causing softening/melting of the plastic material, that becomes irreversibly deformed and relocates as an overhang above the support structure, which when hardened after the local heating is discarded, affixes the support structure to the substrate.

35. A carrier according to claim 33, wherein the gemstone at its lower portion by which it is embedded in the substrate has a surface relief defining at least one indenting region filled by the hardened plastic material of the substrate.

36. A carrier according to claim 34, wherein the support structure at its lower portion by which it is embedded in the substrate has a surface relief defining at least one protruding region wrapper by the hardened plastic material of the substrate.

37. A carrier according to claim 31, wherein said at least one region of the plastic material is produced by applying appropriate heat to the plastic material of the substrate in the vicinity of the gemstone located in the recess, and applying appropriate mechanical pressure; thereby causing softening/melting of the plastic material that becomes irreversibly deformed and relocates as an overhang above the gemstone, which when hardened after the local heating is discarded, affixes the gemstone to the substrate.

38. A carrier according to claim 32, wherein said at least one region of the plastic material is produced by applying appropriate heat to the plastic material of the substrate in the vicinity of the support structure located in the recess, and applying appropriate mechanical pressure; thereby causing softening/melting of the plastic material that becomes irreversibly deformed and relocates as an overhang above the gemstone, which when hardened after the local heating is discarded, affixes the support structure to the substrate.

39. A carrier according to claim 33, wherein said at least one region of the plastic material is produced by directly applying the heat and the mechanical pressure to an upper surface of a heat-conductive gemstone thereby carrying out said application of heat to the plastic material by conducting the heat from the gemstone to the plastic material in the vicinity of the gemstone.

40. A carrier according to claim 33, wherein said at least one region of the plastic material is produced by directly applying the heat and the mechanical pressure to an upper surface of the heat-conductive gemstone while pressing it into the substrate, thereby carrying out said application of heat to the plastic material by conducting the heat from the gemstone to the plastic material in the vicinity of the gemstone.

41. A carrier according to claim 33, wherein said at least one region of the plastic material is produced by separately heating a non heat-conductive gemstone and inserting it, while hot, with the mechanical pressure into the substrate, thereby carrying out said application of heat to the plastic material by conducting the heat from the hot gemstone to the plastic material in the vicinity of the gemstone and affixing the gemstone to the substrate.

42. A carrier according to claim 39, wherein said gemstone is located in a recess pre-prepared in the substrate.

43. A carrier according to claim 41, wherein said gemstone is located in a recess pre-prepared in the substrate.

44. A carrier according to claim 34, wherein said at least one region of the plastic material is produced by directly applying the heat and the mechanical pressure to the heat-conductive support structure thereby carrying out said application of heat to the plastic material by conducting the heat from the support structure to the plastic material in the vicinity of the support structure.

45. A carrier according to claim 34, wherein said at least one region of the plastic material is produced by directly applying the heat and the mechanical pressure to the heat-conductive support structure while pressing it into the substrate, thereby carrying out said application of heat to the plastic material by conducting the heat from the support structure to the plastic material in the vicinity of the support structure.

46. A carrier according to claim 34, wherein said at least one region of the plastic material is produced by separately heating a non heat-conductive support structure and inserting it, while hot, with the mechanical pressure into the substrate, thereby carrying out said application of heat to the plastic material by conducting the heat from the hot support structure to the plastic material in the vicinity of the support structure and affixing the support structure to the substrate.

47. A carrier according to claim 44, wherein said support structure is located in a recess pre-prepared in the substrate.

48. A carrier according to claim 46, wherein said support structure is located in a recess pre-prepared in the substrate.

49. A carrier according to claim 27, wherein said at least one region of the plastic material is produced by carrying out the direct application of heat to the plastic material of the substrate in the vicinity of the gemstone located in a recess pre-prepared in the substrate.

50. A carrier according to claim 28, wherein said at least one region of the plastic material is produced by carrying out the direct application of heat to the plastic material of the substrate in the vicinity of the support structure located in a recess pre-prepared in the substrate.

51. A card according to claim 27, wherein said at least one region of the plastic material is produced by directly applying the heat and the pressure to a heat conductive element located adjacent to the gemstone, thereby carrying out said application of heat to the plastic material by conducting the heat from the heat conductive element to the plastic material of the substrate in the vicinity of the gemstone, thereby affixing the heat-conductive element and the gemstone to the substrate.

52. A carrier according to claim 2, comprising at least one heat-conductive element affixed to the substrate, the heat-conductive element being located adjacent to the at least one of the gemstones.

53. A carrier according to claim 52, wherein the heat-conductive element is mounted onto the gemstone and has at least one region covered by a plastic material of the substrate, being thereby affixed to the substrate and affixing the gemstone to the substrate.

54. A carrier according to claim 52, wherein an upper surface of the gemstone by which it is exposed to view has at least one region covered by a plastic material of the substrate, being thereby affixed to the substrate.

55. A carrier according to claim 53, wherein said at least one region of the plastic material is produced by directly applying appropriate heat and appropriate mechanical pressure to the heat-conductive element, thereby conducting heat to the plastic material of the substrate in the vicinity of the heat-conductive element, causing softening/melting of the plastic material that becomes irreversibly deformed and relocates as an overhang above the heat-conductive element, which when hardened after the local heating is discarded, affixes the heat-conductive element and the gemstone to the substrate.

56. A carrier according to claim 54, wherein said at least one region of the plastic material is produced by directly applying heat and mechanical pressure to the heat-conductive element, thereby conducting heat to the plastic material of the substrate in the vicinity of the gemstone, thereby causing softening/melting of the plastic material that becomes irreversibly deformed and relocates so as to create an overhang, thereby affixing the heat-conductive element and the gemstone to the substrate.

57. A carrier according to claim 52, wherein the gemstone is surrounded by the heat-conductive element embedded in the substrate.

58. A carrier according to claim 52, wherein each of the gemstones together with the respective heat-conductive element is located within a recess made in the substrate.

59. A carrier according to claim 29, wherein the gemstone is affixed to an inner surface of the recess by a clamping member.

60. A carrier according to claim 29, wherein the recess has a substantially cone shape.

61. A carrier according to claim 29, wherein the recess has a lower substantially cone shaped portion and an upper substantially cylindrical portion.

62. A carrier according to claim 61, wherein said upper cylindrical portion of the recess has a diameter substantially equal to that of the cone base.

63. A carrier according to claim 29, wherein the recess has a lower portion shaped and dimensioned to receive a substantial part of the gemstone, and an upper substantially cylindrically shaped portion of a cross-sectional dimension substantially equal to that of the lower portion.

64. A carrier according to claim 61, wherein the upper portion of the recess has a cross-sectional dimension larger than that of the cone base.

65. A carrier according to claim 59, wherein the recess has a lower portion shaped and dimensioned to receive a substantial part of the gemstone, and an upper substantially cylindrically shaped portion of a diameter larger than that of the lower portion.

66. A carrier according to claim 59, wherein said clamping member is configured to be mountable on the gemstone and being insertable into said recess, the clamping member being shiftable between its two low potential energy states through intermediate energy states.

67. A carrier according to claim 66, wherein each of the gemstones is located in the recess and carries the clamping member in the intermediate energy state thereof, being kept by tension in said recess, thereby affixing the gemstone to the substrate.

68. A carrier according to claim 66, wherein said clamping member is configured to be mountable on the gemstone and being insertable into the upper portion of said recess, the clamping member being shiftable between its two low potential energy states through intermediate energy states.

69. A carrier according to claim 68, wherein each of the gemstones is located in the recess and carries the clamping member in the intermediate energy state thereof, being kept by tension in said upper portion of the recess, thereby affixing the gemstone to the substrate.

70. A carrier associated with a certain item, the carrier having a pattern formed by a plurality of diamonds affixed to the carrier with at least part of each diamond being directly exposed to view.

71. An identification card having a plastic substrate carrying a pattern formed by a plurality of gemstones embedded in the plastic material of the substrate with at least part of each gemstone being directly exposed to view.

72. A credit card carrying a pattern formed by a plurality of gemstones embedded in a plastic material of the card with at least part of each gemstone being directly exposed to view.

73. A credit card carrying a pattern formed by a plurality of diamonds embedded in a plastic material of the card with at least part of each diamonds being directly exposed to view.

74. An item carrying a plurality of gemstones mounted such that each of the gemstones is at least partly directly exposed to a viewer, the gemstones being arranged in a pattern configured to be indicative of at least one of an item provider, an item holder and a gemstone provider.

75. An identification card carrying a plurality of gemstones mounted such that each of the gemstones is at least partly directly exposed to a viewer, the gemstones being arranged in a pattern configured to be indicative of at least one of a card provider, a card holder, and a gemstone provider.

76. A credit card carrying a plurality of gemstones mounted such that each of the gemstones is at least partly directly exposed to a viewer, the gemstones being arranged in a pattern associated with at least one of a credit card provider, a credit card holder and a gemstone provider.

77. A method for marking an item to provide an added value to at least one of an item provider, an item holder and a gemstone provider, the method comprising: providing at least a part of the item in the form of a carrier of a pattern formed by a plurality of gemstones arranged such that at least a part of each gemstone is directly exposed to a viewer.

78. A method for marking a credit card to provide an added value to at least one of a card provider, a card holder, and a gemstone provider, the method comprising: providing within at least a part of the card a pattern formed by a plurality of gemstones arranged such that at least a part of each gemstone is directly exposed to a viewer.

79. A method according to claim 78, wherein said certain added value provided to the card provider is associated with at least one of the following: a promotional aspect, and an aspect relative to generating an increase in revenues.

80. A method according to claim 79, wherein said promotional aspect of the certain added value is gained with regard to at least one of an individual and a group of individuals.

81. A method according to claim 80, wherein said at least one of the individual and the group of individuals belongs to a group of rich individuals, said group of rich individuals belonging to a high-class segment of public.

82. A method according to claim 79, wherein said promotional aspect of the certain added value being achieved when said card is becoming collector's items.

83. A method according to claim 79, wherein said increase in revenues is created by said card provider being at least one of a jeweler and a retailer selling gemstones, said card provider selling said cards to individuals, whereby said cards have a credit line to purchase from said card provider at least one of a jewel and a gemstone.

84. A method according to claim 78, wherein said certain added value provided to the card holder is associated with the following: an improvement in social status amongothers; improvement in the marketing benefits that said card holder receives from said card provider; and an increase in revenues produced from selling said card as being a collector's item.

85. A method according to claim 78, wherein said certain added value provided to a gemstone provider is associated with the following aspects: generating an increase in revenues from exclusively selling to the card provider gemstones to be inserted in the card; generation of larger revenues by sales of at least one of jewel and gemstone to the card holder following promotion done by said card provider at the benefit of the gemstone provider against the supply by said gemstone provider to said card provider, at free of charge, of said plurality of gemstones to be presented on the card; getting promotional benefits from said card provider.

86. A method according to claim 85, wherein said promotional benefits are being made at the advantage of the gemstone provider against the supply, at free of charge, from said gemstone provider to the card provider, of said plurality gemstones to be presented on the card.

87. A method according to claim 85, wherein the promotional kind of added value is being generated from said card becoming a collector's item, whereby at least one of a trade-name, a brand-name and a logo of the gemstone provider is being inscribed in said card by the card provider.

88. A method according to claim 78, wherein said certain added value provided to the credit card provider is of a competitive kind as compared to other card providers.

89. A method according to claim 88, wherein said competitive kind of added value is generated by issuing said card to an individual.

90. A method according to claim 89, wherein said card is being positioned as a higher-class credit card, said higher-class credit card positioned higher than current existing high-class cards offered by other card providers.

91. A method according to claim 89, wherein said individual is a top spending individual belonging to a high-class segment of population.

92. A method according to claim 90, wherein said individual is becoming a new customer of said credit card provider.

93. A method according to claim 91, wherein said higher-class credit card is at least one of being proposed and being issued to a segment of carefully sorted out and categorized individuals.

94. A method according to claim 78, wherein the certain added value is of a kind relative to the generation of larger revenues.

95. A method according to claim 94, wherein said larger revenues are being attributed to an increase in credit exercised by a new customer base that is using said card to effectuate purchases.

96. A method according to claim 95, wherein said new customer base is composed of at least one group of new customers and existing customers, being recognized by said card provider as being composed of at least one group of individuals or a group of individuals belonging to a targeted high-class segment of rich individuals, whereby the card provider proposes said cards to said individuals and issues said cards to at least part of said individuals that declare to be interested in said cards.

97. A method according to claim 95, wherein said larger revenues are being attributed to said cards being purchased from the card provider, while having a credit line to purchase at least one of the gemstones and jewelry from the card provider.

98. A method for affecting relation between at least two of an item provider, item holder and a gemstone provider, the method comprising affixing to at least a part of the item a plurality of gemstones arranged in a certain pattern directly exposed to a viewer, said pattern being associated with at least one of the item provider, the item holder and the gemstone provider.

99. A method for affecting relation between at least two of a credit card provider, credit card holder and a gemstone provider, the method comprising embedding in a plastic material of the card a plurality of gemstones arranged in a certain pattern directly exposed to a viewer, said pattern being associated with at least one of the credit card provider, the credit card holder and the gemstone provider.

100. A method for affixing at least one gemstone to a carrier, the method comprising: affixing said at least one gemstone to a plastic substrate of the carrier in a manner leaving at least a part of the upper surface of the gemstone directly exposed to a viewer, said affixing comprising at least one of the following:
(i) directly embedding said at least one gemstone in the plastic material by applying heat to a plastic material of the substrate in the vicinity of the gemstone or an element mounted on the gemstone, thereby causing softening/melting of the plastic material in the vicinity of the gemstone or in the vicinity of said element so that said softened/melted plastic material irreversibly deforms and relocates, thereby creating at least one overhang above at least one region of the gemstone or of said element, said at least one overhang when hardened after the local heating is discarded affixing the gemstone to the plastic substrate;
(ii) providing a support structure carrying on its upper surface said at least one gemstone, and affixing said support structure to the substrate by applying heat to a plastic material of the substrate in the vicinity of said structure, thereby causing softening/melting of the plastic material in the vicinity of the support structure so that said plastic material in the vicinity of the support structure irreversibly deforms and relocates, thereby creating at least one overhang above at least one region of the support structure, said at least one overhang of the plastic material when hardened after the local heating is discarded affixing the support structure to the plastic substrate;
(iii) providing a clamping member configured to be mountable onto the gemstone, and to be shiftable from its one low potential energy state into its other low potential energy state through intermediate energy states; forming a recess in the substrate configured to receive therein the gemstone with the clamping member mounted thereon while in said one low potential energy state; shifting the clamping member towards its other low potential state thereby causing the clamping member to be stopped, by the gemstone inserted in the recess, in the intermediate energy state before reaching said other low potential energy state, and to be thereby kept by tension in said recess, thereby affixing the gemstone to said recess.

101. A method according to claim 100(i), comprising applying mechanical pressure to the gemstone.

102. A method according to claim 100(ii), comprising applying mechanical pressure to the support structure.

103. A method according to claim 100(i), comprising pre-preparing a recess in the substrate to receive the gemstone therein.

104. A method according to claim 100(ii), comprising pre-preparing a recess in the substrate to receive the support structure therein.

105. A method according to claim 100(i), wherein the gemstone, on its lower portion by which it is embedded in the plastic material, is formed with a surface relief defining at least one indentation, thereby causing the softened/melted plastic material to fill said at least one indentation thereby affixing the gemstone to the substrate.

106. A method according to claim 103, wherein the gemstone, on its lower portion by which it is embedded in the plastic material, is formed with a surface relief defining at least one indentation, thereby causing the softened/melted plastic material to fill said at least one indentation thereby affixing the gemstone to the substrate.

107. A method according to claim 100(i), wherein the support structure, on its lower portion by which it is embedded in the plastic material, is formed with a surface relief defining at least one protrusion, thereby causing the softened/melted plastic material to wrap said at least one protrusion thereby affixing the support structure to the substrate.

108. A method according to claim 104, wherein the support structure, on its lower portion by which it is embedded in the plastic material, is formed with a surface relief defining at least one protrusion, thereby causing the softened/melted plastic material to wrap said at least one protrusion thereby affixing the support structure to the substrate.

109. A method according to claim 100(i), wherein said application of heat is carried out via the gemstone by transferring heat from the gemstone to the plastic material in the vicinity thereof.

110. A method according to claim 109, comprising applying mechanical pressure to the gemstone.

111. A method according to claim 107, wherein the gemstone is heat-conductive.

112. A method according to claim 107, wherein the gemstone is heated separately and, while hot, is inserted into the substrate.

113. A method according to claim 100(ii), wherein said application of heat to the plastic material is carried out via the support structure by transferring heat from the support structure to the plastic material in the vicinity thereof.

114. A method according to claim 113, comprising applying mechanical pressure to the support structure.

115. A method according to claim 113, wherein the support structure is heat-conductive.

116. A method according to claim 113, wherein the support structure is heated separately and, while hot, is inserted into the substrate.

117. A method according to claim 100(i), wherein said application of heat to the plastic material is carried out via a heat conductive element located adjacent to the gemstone, thereby conducting heat to the plastic material in the vicinity of the heat conductive element and affixing both the heat conductive element and the gemstone to the substrate.

118. A method according to claim 100(i), wherein said application of heat to the plastic material is carried out via direct application of heat to the plastic material in the vicinity of a recess containing the gemstone.

119. A method according to claim 118, comprising applying mechanical pressure to at least one of the heated plastic material and the gemstone.

120. A method according to claim 100(ii), wherein said application of heat to the plastic material is carried out via direct application of heat to the plastic material in the vicinity of a recess containing the support structure.

121. A method according to claim 118, comprising applying mechanical pressure to at least one of the heated plastic material and the support structure.

122. A method according to claim 103, wherein initial dimensions of said recess, prior to the heat application, are smaller than those of at least a part of the gemstone to be placed therein.

123. A method according to claim 104, wherein initial dimensions of said recess, prior to the heat application, are smaller than those of at least a part of the support structure to be placed therein.

124. A method according to claim 100, wherein said gemstone is a diamond.

125. A method according to claim 124, wherein the diamond is a polished diamond.

126. A method according to claim 125, wherein the polished diamond has a cut defining a table, at least a part of the table being free of plastic overhang.

127. A method according to claim 100, wherein the gemstone is polished in a cut defining a table, at least a part of the table being free of plastic overhang.

128. A processing tool for use in affixing a gemstone in a plastic substrate, the tool being designed to apply heat to a material brought in contact with the tool, the tool being configured to define a plurality of protrusions arranged in a spaced-apart relationship along a predetermined curve, each protrusion for contacting the corresponding one of a contacting regions of the material.

129. A tool according to claim 128, designed to apply heat and required pressure to the material.

130. A clamping member for use in attaching an object to a recess made in a plastic substrate, the clamping member being a spring, configured to be mountable onto the object and to be shiftable from its one low potential energy state to other low potential energy state though its intermediate energy states.

131. A clamping member according to claim 130, configured to be mountable on an upper part of a gemstone, such that when being shifted from its one low potential energy state into the other, is prevented from reaching the other low potential energy state by the upper part of the gemstone while located in the recess, the clamping member thereby remaining in its intermediate energy state.
